(19) United States
(12) Patent Application Publication
(10) Pub. No.: US 2004/0042411 A1
(43) Pub. Date: Mar. 4, 2004

(54) Method and apparatus for controlling the rate of path searching in a communications system

(76) Inventors: Erik Dahlback, Veberod (SE); Robert Svensson, Lund (SE)

Correspondence Address: JENKENS & GILCHRIST, P.C., 3200 Fountain Place, 1445 Ross Avenue, Dallas, TX, 75202-2799, US

(21) Appl. No.: 10/232,282

(22) Filed: Aug. 30, 2002

(51) Int. Cl. H04L 12/26

(52) U.S. Cl. 370/252; 370/238

(57) ABSTRACT

A method and apparatus for controlling a rate of path searching for a channel in a communication system include searching for new path delays and identifying a number of new path delays during a specific time period. The identified number of new path delays are compared to at least one threshold value. The result of the comparison is used to alter the rate of path searching.

### BACKGROUND OF THE INVENTION

1. Technical Field of the Invention

The present invention relates in general to the detection of new path delays and corresponding path energies for a channel in a cellular radio communications system, and in particular to controlling the power efficiency of a path searcher unit by varying the search rate during channel estimation.

2. Description of Related Art

Access to and use of wireless networks is becoming increasingly important and popular for business, social, and recreational purposes. Users of wireless networks now rely on them for both voice and data communications. Furthermore, an ever increasing number of users demand both an increasing array of services and capabilities as well as greater bandwidth for activities such as Internet surfing. To address and meet the demands for new services and greater bandwidth, the wireless communications industry constantly strives to improve the number of services and the throughput of their wireless networks.

To that end, the wireless communications industry intends to continue to improve the capabilities of the technology upon which it relies and that it makes available to its customers by developing next-generation system(s). Protocols for a next-generation standard that is designed to meet the developing needs of wireless customers are being standardized by the 3^{rd} Generation Partnership Project (3GPP). This set of protocols is known collectively as Universal Mobile Telecommunications System (UMTS).

The UMTS network consists of three independent domains namely a core network, a UMTS Terrestrial Radio Access Network (UTRAN) and User Equipment (UEs). The UEs may include for example, mobile stations, mobile terminals, etc. The main function of the network is to provide switching, routing, and transit for user traffic.

An important consideration of mobile terminals in a communications system is that of stand-by time. Stand-by time of a mobile terminal represents the maximum battery life of a mobile terminal when not in use for a conversation. To increase the stand-by time of a mobile terminal, the power consumption when the mobile terminal is turned on but not in use should be minimized. Power consumption can be minimized by powering off different components in the mobile terminal, such as signal processing circuitry, when the mobile terminal is not in use. For example, power consumption can be minimized by limiting the time a path searching unit searches for the presence of path delays.

The main object of the path searcher unit is to determine path delays. In conventional procedures, the path searcher unit periodically searches for path delays. In other words, the path searcher unit is activated during fixed intervals of time in order to determine path delays having higher power or higher Signal-to-Interference ratio (SIR) than the previously known path delays. The rate at which path delays appear is a complex function of terminal speed and the environment. Because the path searcher unit is a high power consuming function, there is a need to improve the power efficiency of the path searcher unit while searching for path delays for a channel in a communications system.

### SUMMARY OF THE INVENTION

Embodiments of the present invention include a method and apparatus for controlling a rate of path searching for a channel in a communications system. In accordance with an embodiment of the invention, there is provided a method in which a search is performed for new path delays in a multipath communications environment. An estimated number of new path delays are identified during a specific time period. The identified number of new path delays are compared to at least one threshold value. The comparison results are utilized for altering the rate of path searching.

In accordance with another embodiment of the invention, controlling a rate of path searching for a channel is implemented in an apparatus that includes a searcher unit for searching new path delays in a multipath communications environment. The apparatus further includes a control unit for identifying a number of new path delays and comparing the number of new path delays to at least one threshold value. Furthermore, the apparatus includes a logic unit for selectively altering the rate of path searching based on the results of the comparison.

### BRIEF DESCRIPTION OF THE DRAWINGS

For a more complete understanding of the present invention, reference is made to the following detailed description taken in conjunction with the accompanying drawings, wherein:

FIG. 1 is a block diagram of a conventional wireless UMTS communication system, in which the present invention can be implemented;

FIG. 2 is a simplified block diagram of a conventional system for detecting path delays for a channel in a communications system;

FIG. 3 is a flow diagram of a conventional procedure for detecting path delays for a channel in a communications system;

FIG. 4 is a block diagram that shows pertinent details of an exemplary searcher unit that can be used to implement the functions of the searcher unit(s) shown in FIGS. 3 and 5;

FIG. 5 is a block diagram of an apparatus for controlling the rate of path searching in a communications system in accordance with an embodiment of the present invention; and

FIG. 6 is a flow diagram of a method for controlling the rate of path searching in accordance with principles of the present invention.

### DETAILED DESCRIPTION OF THE INVENTION

Reference is now made to the Drawings, wherein like reference characters denote like or similar parts throughout the various FIGURES. In a preferred embodiment, the present invention is implemented in a UMTS system. Accordingly, the following description and examples focus primarily on the use of embodiments of the invention in connection with a UMTS system. As will be appreciated by persons of ordinary skill in the art, however, the invention can be implemented in other wireless communication systems, such as, for example, CDMA and TDMA.

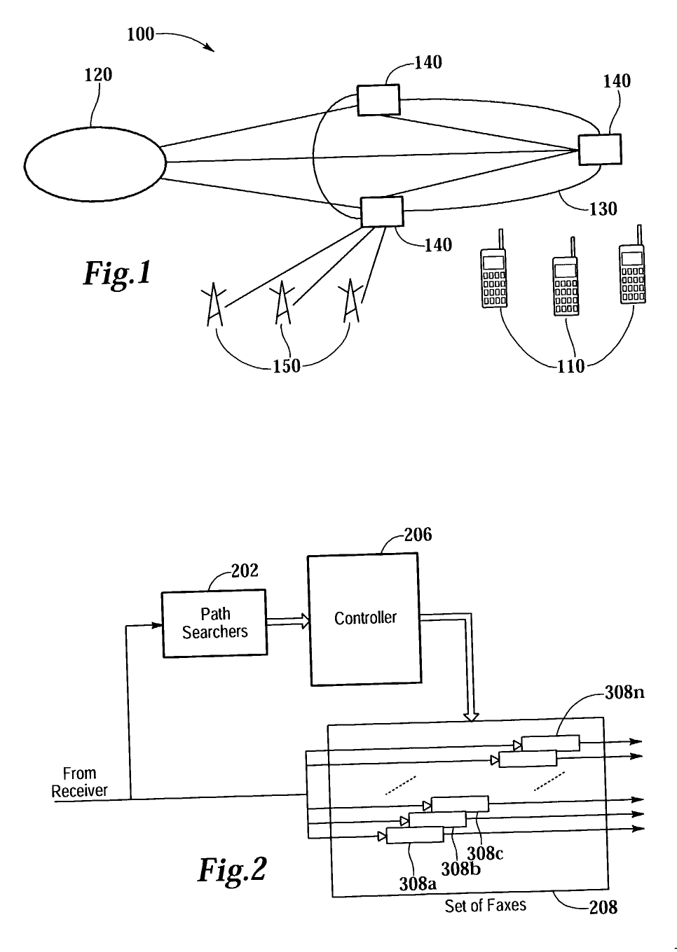

Referring now to FIG. 1, there is illustrated a block diagram of a UMTS wireless communications system 100. The network 100 includes a core network 120 and a UMTS Terrestrial Radio Access Network (UTRAN) 130. The UTRAN 130 is composed of, at least partially, a number of Radio Network Controllers (RNCs) 140, each of which may be coupled to one or more neighboring base stations (BSs) 150. Each BS 150 is responsible for a given geographical cell and the controlling RNC 140 is responsible for routing user and signaling data between the BS 150 and the core network 120. All of the RNCs 140 may be directly or indirectly coupled to one another. The UMTS network 100 may further include multiple user equipment (UEs) 110. The UE 110 may include, for example, mobile stations or mobile terminals that communicate with the base stations 150 via radio interfaces.

As known in the art, radio channels are severely impacted by the presence of multipath propagation. In multipath propagation, the propagating signal is reflected from a number of objects in the physical environment, and the various multipath components from the different radio paths arrive at a receiving device at slightly different times due to the time delays associated with the multipath propagation.

Referring now to FIG. 2, a simplified block diagram of a conventional system 200 for detecting path delays for a channel by a path searching unit is illustrated. The system 200 shown includes at least one path searcher unit 202. A function of the path searcher unit 202 is to detect/find path delays corresponding to different paths in a multipath environment. The path searcher unit 202 in the conventional system periodically searches for path delays. This means that the path searcher unit 202 is activated at fixed intervals of time and performs a path searching operation at the same rate even when no path delays exist. This detection and searching process provides, for example, the path delay information and also provides channel estimations, if so desired. In short, the primary function of the one or more path searching units 202 is to detect path delays for different paths in a multipath environment, where each different path has a different propagation time.

The output of the one or more path searcher units 202 are coupled to the control unit 206. A control signal from the control unit 206 includes path delay estimates that are used to set correct delays in a RAKE receiver unit 208. Each Rake receiver component (or RAKE finger) 208a-208n demodulates the information received on a propagation path that corresponds to one of the received path delay estimates.

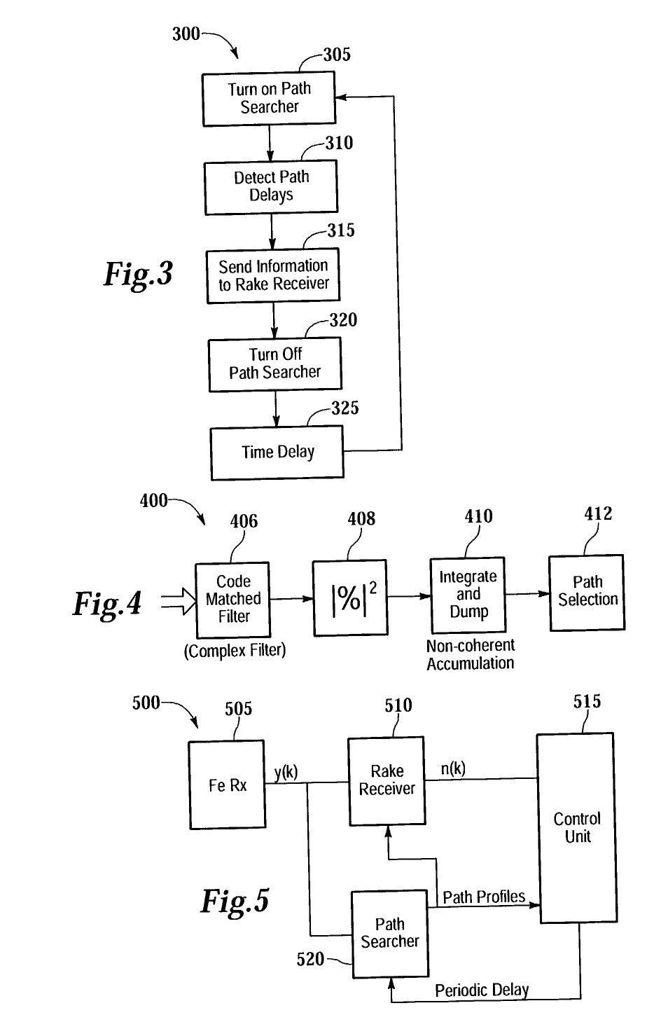

Referring now to FIG. 3, there is shown a flow diagram of a conventional procedure 300 for detecting path delays for a channel by a path searching unit. In step 305, the path searcher unit 202 is activated or turned on. The purpose of the path searcher unit 202 is to acquire accurate estimates of the time of arrival and amplitude of various multipath components (step 310). At step 315, path delay information acquired by the path searcher unit 202 is conveyed to the RAKE receiver.

Once the path delay information is received by the RAKE receiver, the path searcher unit 202 is deactivated or turned off (step 320). At step 325, the process waits for the expiration of a constant time delay, after which the path searcher unit 202 is again activated to detect path delays by repeating steps 305-320. The conventional procedure for detecting path delays requires the path searcher unit 202 to perform the path searching operation at the same rate even when no path delays exist. Each such path search consumes power and thereby reduces the stand-by time of the mobile terminal 110.

Referring now to FIG. 4, there is shown a block diagram that shows pertinent details of an exemplary path searcher unit 400. The exemplary searcher unit 400 includes a code matched filter 406, which is matched to a pilot sequence of a dedicated data channel being used. The absolute value squared 408 of the complex signal output from the matched filter 406 is non-coherently accumulated in an integrate and dump unit 410 because of the frequency offset of the input signal complex signal. A path selection unit 412 searches for the highest peaks in the output from the integrate and dump unit 410 by comparing each peak with a predetermined threshold value. The path delays associated with the highest peak signal values are output to the control unit 306 (FIG. 3), to be used for selecting RAKE finger 308a-308n (FIG. 3).

In accordance with principles of the present invention, the stand-by time of a mobile terminal 110 can be improved by controlling the search rate of a path searcher unit 202 during channel estimation. To increase the stand-by time of a mobile terminal 110, the search rate of a path searcher unit within the mobile terminal 110 while searching for new path delays is selectively altered based upon the number of new path delays detected during a specific time period.

If it is determined by the path searcher unit 202 or by a control unit in response to data provided by the path searcher that the number of new path delays detected is considerably small or if no new path delays exist, the search rate of the path searcher unit 202 can be decreased. However, if it is determined by the path searcher unit 202 that the number of new path delays detected is considerably large or if new path delays exist, the search rate of the path searcher unit 202 can be increased. Thus, by varying the search rate of the path searcher unit 202 in accordance with the path profile estimates, the stand-by time of the mobile terminal 110 can be prolonged.

Referring now to FIG. 5, there is illustrated an apparatus 500 for controlling the rate of path searching in accordance with an embodiment of the present invention. The path searcher unit 520 is periodically activated to detect new path delays. More specifically, the rate of path searching or the periodic interval during which the path searcher unit 520 is active is varied based upon the number of new path delays detected in comparison to at least one threshold value. The number of new path delays detected is utilized to calculate a timer value T that indicates the rate of path searching.

The timer value T is generally based on the number of new path delays detected by the path searcher unit 520. If the number of new path delays detected is greater than a threshold value τ, the timer value T is decreased thereby activating the path searcher unit more frequently and after shorter periodic delays. This increases the rate of path searching.

However, if the number of new path delays detected is less than the threshold value τ, the timer value T is increased thereby activating the path searcher unit less frequently and after longer periodic delays. Thus, the rate of path searching is decreased. In one embodiment, the timer value T is increased if any new path delays are detected and is only decreased if no new path delays are detected.

In an exemplary embodiment of the present invention, a front end receiver (FeRx) 505 is enabled to begin receiving data y(k). Due to multipath propagation, the various multipath components from the different radio paths arrive at a receiving device at slightly different times due to the delays associated with the multipath propagation. The received signal y(k) is provided to a RAKE receiver 510. As known in the art, the RAKE receiver remedies the effect of multipath propagation by using several baseband correlators to individually process several signal multipath components. The correlator outputs are combined to achieve improved communications reliability and performance.

The received signal y(k) is simultaneously provided to the path searcher unit 520 which periodically searches for new path delays. The path searcher unit 520 may contain one or more correlators which scan the time delay for a short period of time looking for strong signals. The path searcher unit 520 provides the path delay estimates to the control unit 515. The control unit 515 utilizes the path delay estimates to determine whether new path delays exist.

If it is determined by the control unit 515 that no new path delays exist, the control unit 515 increases the timer value T. This timer value T is loaded into a timer, which counts down from the loaded timer value T and activates the path searcher unit 520 after a time interval equal to T. In other words, the control unit 515 increases the delay between the periodic intervals at which the path searcher unit 520 searches for new path delays. Thus, the rate of path searching is reduced.

However, if it is determined by the control unit 515 that new path delays exist, the control unit performs a comparison of the number of new path delays detected with a threshold value τ. If it is determined that the number of new path delays detected is greater than the threshold value τ, the control unit 515 decreases the timer value T. This timer value T is loaded into the timer. As stated above, the timer counts down from the loaded timer value T and activates the path searcher unit 520 after a time interval equal to T. The timer value T, in this case, is set such that it decreases the delay between the periodic intervals at which the path searcher unit 520 will search for new paths, thus, increasing the rate of path searching.

In an illustrative embodiment, the threshold value τ is effectively set such that 0<τ<1. More specifically, if no new path delays exist or if the number of new path delays detected (n) is less than the threshold value T (i.e., n=0), the timer value T loaded into the timer equals T=T*2, where T can be any maximum T value.

However, if it is determined that the number of new path delays detected is greater than the threshold value τ (i.e., n≧1) , the maximum timer value T loaded into the timer equals T=T/2, where T can be any minimum T value. Thus, the rate of path searching is altered by varying the delay between the periodic intervals at which the path searcher unit 520 searches for the presence of new path delays.

In another embodiment of the present invention, the number of new path delays detected (n) are compared to multiple threshold values τ1and τ2. As stated above, the path searcher unit 520 provides the path delay estimates to the control unit 515. If it is determined by the control unit 515 that new path delays exist, the control unit performs a comparison of the number of new path delays detected with a first threshold value τ1. For example, the first threshold value τ1 can be effectively set to identify situations in which a relatively large number of new path delays exist.

If it is determined that the number of new path delays detected (n) is greater than the first threshold value τ1 (e.g., n≧3), the timer value T loaded into the timer equals T=T/4, down to some minimum T value. In other words, the value of T will be substantially decreased, but it will not go below a predetermined minimum T value (e.g., T=max (T/4, min value T)) . This rapidly decreases the delay between which the path searcher unit 520 searches for new path delays, thus, increasing the rate of path searching.

However, if it is determined that the number of new path delays detected (n) is less than the first threshold value τ1, then a second comparison is performed between the number of new path delays detected with a second threshold value τ2. For example, the second threshold value τ2 can be effectively set such that 0<τ2<1. If it is determined that the number of new path delays detected is less than the first threshold value τ1 but is greater than the second threshold value τ2 (i.e., τ2<n<τ1), the timer value T loaded into the timer equals T=T/2, down to some minimum T value (e.g., T=max(T/2, min value T)).

However, if the number of new path delays detected is less than the first threshold value τ1 and is also less than the second threshold value (i.e., n<τ2), the timer value T loaded into the timer equals T=T*2. Thus, the rate of path searching is decreased. This example results in an increase in the path search rate if new paths exist and a decrease in the path search rate if no new paths exist.

Although the foregoing example uses only two thresholds, it will be understood by persons of ordinary skill in the art that any number of thresholds can be used in connection with the invention. In addition, the mechanism for increasing or decreasing the path search rate is not limited to the disclosed examples but can use any type of algorithm or process for increasing or decreasing the path search rate. It will be understood that, for some number of new path delays (e.g., n=1), it is possible for the timer value T to remain unchanged. In such a case, for example, the path search rate would decrease at times when no new paths are detected, would remain unchanged if one new path is detected, and would increase if more than one new path is detected.

In yet another embodiment of the present invention, the control unit 515 uses the output x(k) from the RAKE receiver 510 to determine if one or more of the strongest signal paths disappear during a short interval of time. An estimated Signal-to-Interference ratio (SIR), or a measure of the signal strength relative to background noise can be utilized to vary the rate of path searching. More specifically, during the time the path searcher unit 520 is periodically inactive, the control unit checks to see if at least one of the strongest signal paths is decreasing in SIR at or above a certain rate.

In a preferred embodiment of the present invention, if one of the strongest SIR for a rake finger is decreasing (y) dB during (z) slots, then the timer value T loaded into the timer is immediately set to zero and the path searcher unit is activated instantaneously. This will help to ensure that the receiver continues to receive a combined signal of sufficient strength to adequately detect the transmitted information. However, if none of the strongest signal paths are decreasing in SIR at or above a certain rate, then the timer value T remains unchanged at least until the next time it is determined whether there are any new paths.

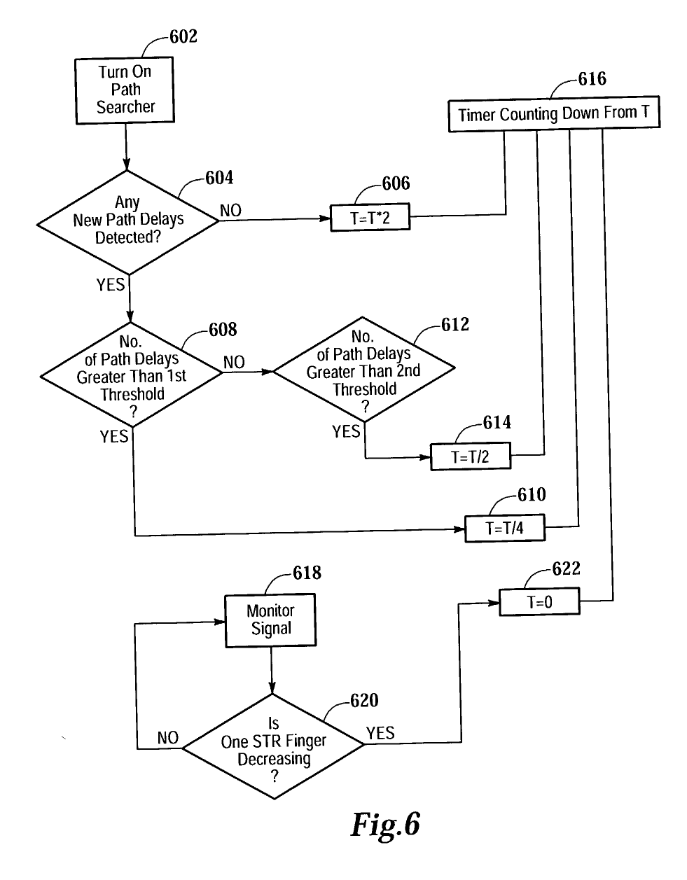

Referring now to FIG. 6, there is illustrated a flow diagram 600 of a method for controlling the rate of path searching in accordance with principles of the present invention. Although the steps of the method are depicted in a particular sequence, it will be appreciated by persons of ordinary skill in the art that certain steps of the method do not necessarily follow a strict sequence but can be rearranged and/or performed simultaneously. At step 602, the path searcher unit 520 is activated for a fixed period of time to search for new path delays. The path searcher unit 520 forwards path delay estimates, which are used to determine whether new path delays exist.

At step 604, the received path delay estimates are monitored to determine if any new path delays exist. If it is determined that no new path delays exist, a timer value equal to T=T*2 (step 606) is loaded into the timer at step 616. In other words, since no new path delays were detected at step 606, the rate of path searching is reduced by increasing the periodic time delay during which the path searcher unit 520 searches for the presence of new path delays.

However, if it is determined at step 604 that new path delays exist, then at step 608, a comparison is performed between the number of new path delays detected with a first threshold value. If the comparison indicates that the number of new path delays is greater than the first threshold value (step 608) a timer value equal to T=T/4 (step 610) is loaded into a timer at step 616. More specifically, since the number of new path detected was greater than a first threshold value at step 608, the rate of path searching is increased by loading a timer with a value that significantly decreases the periodic time delay during which the path searcher unit 520 searches for the presence of new path delays, thereby quickly increasing the rate of path searching.

On the other hand, if the comparison at step 608 indicates that the number of new path delays is less than the first threshold value, a comparison is performed at step 612 between the number of new path delays detected with a second threshold value. If it is determined that the number of new path delays detected is greater than the second threshold value (step 612) a timer value equal to T=T/2 (step 614) is loaded into a timer at step 616. More specifically, since the number of new path detected was less than the first threshold value at step 608, but greater than the second threshold value (step 612), the rate of path searching is increased but not as quickly as at step 610.

However, if it is determined at step 612 that the number of new path delays is both less than the first threshold value (step 608) and less than the second threshold value (step 612), the rate of path searching remains unchanged and the timer is loaded at step 616 with a value that does not change the periodic time delay during which the path searcher unit 520 searches for the presence of new path delays.

It will be understood that the embodiment of the invention depicted in FIG. 6 represents a process with three threshold comparisons one at each of steps 604, 608, and 612. In other embodiments, it is possible to use more or fewer thresholds. For example, step 612 could be omitted, and a negative result of the comparison at step 608 would lead to step 614. This omission would results in a change to the timer value T after each and every path search.

Additionally, to take into account any significant changes in path delays while the path searcher unit 520 is inactive, the Signal-to-Interference ratio (SIR) , or the measure of the signal strength relative to background noise, is constantly monitored at step 618. Based on this monitoring, it is determined at step 620 if one or more of a selected number of the strongest signal paths disappear or otherwise decrease at or above some predetermined amount during a short interval of time. If it is determined at step 620 that none of the signal paths have disappeared or are decreasing at or above a certain rate, the SIR monitoring continues at step 618.

If it is determined that at least one of the signal paths disappears or decreases at or above a certain rate, then at step 622 a timer value equal to T=0 is loaded into the timer at step 616, thus, activating the path searcher unit 520 instantaneously. Generally, the process of steps 618-622 is performed in parallel with steps 602-616.

Although preferred embodiment(s) of the method and apparatus of the present invention have been illustrated in the accompanying Drawings and described in the foregoing Detailed Description, it is understood that the present invention is not limited to the embodiment(s) disclosed, but is capable of numerous rearrangements, modifications, and substitutions without departing from the spirit of the invention as set forth and defined by the following claims.

What is claimed is:

1. A method for controlling a rate of path searching for a channel in a communications system, said method comprising:
searching for new path delays in a multipath communications environment;
identifying a number of new path delays during a specific time period;
comparing said identified number of new path delays to at least one threshold value; and
selectively altering said rate of path searching based on said comparison.

2. The method of claim 1, wherein said at least one threshold value comprises a first threshold value, further comprising the step of determining whether said identified number of new path delays is greater than said first threshold value and wherein said step of selectively altering said rate of path searching based on said comparison comprises increasing said rate of path searching by a first amount if said identified number of new path delays is greater than said first threshold value.

3. The method of claim 2, wherein said at least one threshold value further comprises a second threshold value, further comprising the step of determining whether said identified number of new path delays is greater than said second threshold value and wherein said step of selectively altering said rate of path searching based on said comparison comprises increasing said rate of path searching by a second amount if said identified number of new path delays is less than said first threshold value and is greater than said second threshold value, wherein said second amount is less than said first amount.

4. The method of claim 3, wherein said step of selectively altering said rate of path searching based on said comparison comprises leaving said rate of path searching unchanged if said identified number of new path delays is less than said first threshold value and is greater than said second threshold value.

5. The method of claim 2, wherein said first threshold value is greater than one and said second threshold value is greater than zero and less than one.

6. The method of claim 1, further comprising the step of determining whether said identified number of new path delays is less than said at least one threshold value and wherein said step of selectively altering said rate of path searching based on said comparison comprises decreasing said rate of path searching if said identified number of new path delays is less than said at least one threshold value.

7. The method of claim 1, wherein said communications system comprises a UMTS system.

8. The method of claim 1, further comprising:
estimating a signal quality value associated with each of a plurality of previously identified path delays;
determining if each said signal quality value is decreasing at or above a predetermined rate; and
selectively altering said rate of path searching based on said determination.

9. The method of claim 8, wherein said estimated signal quality value comprises an estimate of a signal-to-interference ratio (SIR).

10. The method of claim 8, wherein said step of selectively altering said rate of path searching based on said determination comprises increasing said rate of path searching if any of said signal quality values are decreasing at or above said predetermined rate.

11. The method of claim 8, wherein said step of selectively altering said rate of path searching based on said determination comprises leaving said rate of path searching unchanged if none of said signal quality values are decreasing at or above said predetermined rate.

12. An apparatus for controlling a rate of path searching for a channel in a communications system, said apparatus comprising:
a searcher unit for searching new path delays in a multipath communications environment;
a control unit for identifying a number of new path delays during a specific time period; and
said control unit for further comparing said identified number of new path delays to at least one threshold value and for selectively altering said rate of path searching based on said comparison.

13. The apparatus of claim 12, wherein said at least one threshold value comprises a first threshold value, said control unit operable to:
determine whether said identified number of new path delays is greater than said first threshold value; and
increase said rate of path searching by a first amount if said identified number of new path delays is greater than said first threshold value.

14. The apparatus of claim 13, wherein said at least one threshold value further comprises a second threshold value, said control unit operable to:
determine whether said identified number of new path delays is greater than said second threshold value; and
increase said rate of path searching by a second amount if said identified number of new path delays is less than said first threshold value and is greater than said second threshold value.

15. The apparatus of claim 14, wherein said control unit is operable to leave said rate of path searching unchanged if said identified number of new path delays is less than said first threshold value and is less than said second threshold value.

16. The apparatus of claim 12, wherein said control unit is operable to:
determine whether said identified number of new path delays is less than said at least one threshold value; and
decrease said rate of path searching if said identified number of new path delays is less than said at least one threshold value.

17. The apparatus of claim 12, wherein said control unit is operable to:
estimate a signal quality value associated with each of a plurality of known path delays;
determine if any of said signal quality values are decreasing at or above a predetermined rate; and
selectively alter said rate of path searching based on said determination.

18. The apparatus of claim 17, wherein said estimated signal quality value comprises an estimate of a signal-to-interference ratio (SIR).

19. The apparatus of claim 17, wherein said control unit is operable to increase said rate of path searching if at least one said signal quality value is decreasing at or above said predetermined rate.

20. The apparatus of claim 17, wherein said control unit is operable to leave said rate of path searching unchanged if none of said signal quality values are decreasing at or above said predetermined rate.

21. The apparatus of claim 12, wherein said communications system comprises a UMTS system.

22. A method for controlling a rate of path searching for a channel in a communications system, said method comprising:
searching for new path delays in a multipath communications environment;
identifying a number of new path delays during a specific time period;
comparing said identified number of new path delays to a first threshold value;
determining whether said identified number of new path delays is greater than said first threshold value; and
increasing said rate of path searching if said identified number of new path delays is greater than said first threshold value.

23. The method of claim 22, further comprising the step of determining whether said identified number of new path delays is greater than a second threshold value and increasing said rate of path searching by a second amount based on said comparison if said identified number of new path delays is less than said first threshold value and is greater than said second threshold value.

24. The method of claim 23, wherein said second threshold value is less than said first threshold value, further comprising leaving said rate of path searching unchanged if said identified number of new path delays is less than said first threshold value and is less than second threshold value.

25. The method of claim 22, further comprising:
estimating a signal quality value for each of a plurality of previously identified path delays;
determining if any of said signal quality values are decreasing at or above a predetermined rate; and
selectively altering said rate of path searching based on said determination.

26. The method of claim 25, wherein said estimated signal quality value comprises an estimate of a signal-to-interference ratio (SIR).

27. The method of claim 25, wherein said step of selectively altering said rate of path searching based on said determination comprises increasing said rate of path searching if any of said signal quality values are decreasing at or above said predetermined rate.

28. The method of claim 25, wherein said step of selectively altering said rate of path searching based on said determination comprises leaving said rate of path searching unchanged if none of said signal quality values are decreasing at or above said predetermined rate.
